(19) United States
(12) Patent Application Publication
(10) Pub. No.: US 2022/0358702 A1
(43) Pub. Date: Nov. 10, 2022

(54) ANIMATION PRODUCTION SYSTEM

(71) Applicants: XVI Inc., Chuo-ku (JP); Avex Technologies Inc., Minato-ku (JP)

(72) Inventors: Yoshihito KONDOH, Chuo-ku (JP); Masato MUROHASHI, Tokyo (JP)

(21) Appl. No.: 16/977,055

(22) PCT Filed: Sep. 24, 2019
(86) PCT No.: PCT/JP2019/037408

§ 371 Date: Aug. 31, 2020

(51) Int. Cl. G06T 13/20; H04N 5/232

(52) U.S. Cl. CPC G06T 13/20; H04N 5/23296

(57) ABSTRACT

[Technical Problem] To enable to shoot animations in a virtual space. [Solution to Problem] An animation production system comprises a virtual camera that takes a picture of a character placed in a virtual space, a user input detection unit that detects an input of a user from at least one of a head mounted display and a controller which the user mounts, and a camera control unit that controls the camera in response to the input,

### TECHNICAL FIELD

The present invention relates to an animation production system.

### BACKGROUND ART

Virtual cameras are arranged in a virtual space (see Patent Document 1).

### CITATION LIST

### Patent Literature

[PTL 1] Patent Application Publication No. 2017-146651

### SUMMARY OF INVENTION

### Technical Problem

No attempt was made to capture animations in the virtual space.

The present invention has been made in view of such a background, and is intended to provide a technology capable of shooting animations in a virtual space.

### Solution to Problem

The principal invention for solving the above-described problem is an animation production system, comprising: a virtual camera for taking a character disposed in a virtual space; a user input detection unit for detecting the user input from at least one of a head mount display and a controller mounted by a user; and a camera control unit for controlling the camera in response to the input.

The other problems disclosed in the present application and the method for solving them are clarified in the sections and drawings of the embodiments of the invention.

### Advantageous Effects of Invention

According to the present invention, animations can be captured in a virtual space.

### BRIEF DESCRIPTION OF DRAWINGS

FIG. 1 is a diagram illustrating an example of a virtual space displayed on a head mount display (HMD) mounted by a user in an animation production system 300 of the present embodiment.

FIG. 2 is a diagram illustrating an example of the overall configuration of an animation production system 300 according to an embodiment of the present invention.

FIG. 3 is a diagram schematically illustrating the appearance of the HMD 110 according to the present embodiment.

FIG. 4 is a diagram illustrating an example of a functional configuration of the HMD 110 according to the present embodiment;

FIG. 5 is a diagram schematically illustrating the appearance of the controller 210 according to the present embodiment.

FIG. 6 is a diagram illustrating an example of a functional configuration of a controller 210 according to the present embodiment;

FIG. 7 is a diagram illustrating an example of a functional configuration of an image producing device 310 according to the present embodiment;

FIG. 8 is a diagram illustrating the operation of the camera 3 by the camera man 2 in the animation production system 300 according to the present embodiment;

FIG. 9 is a diagram illustrating an operation of an animation production system 300 according to the present embodiment;

### DESCRIPTION OF EMBODIMENTS

The contents of embodiments of the present invention will be described with reference. The present invention includes, for example, the following configurations.

### [Item 1]

An animation production system comprising:

a virtual camera that takes a picture of a character placed in a virtual space,

a user input detection unit that detects an input of a user from at least one of a head mounted display and a controller which the user mounts, and

a camera control unit that controls the camera in response to the input,

### [Item 2]

The animation production system according to claim 1, further comprising a slider parallel to a shooting direction of the camera,

wherein the camera control unit moves the slider in response to the input and determines the zoom of the camera according to the position of the slider.

### [Item 3]

The animation production system according to claim 1, wherein

the camera includes a virtual handle,

a photographer character who operates the camera is disposed in the virtual space, and

the camera control unit controls the movement of a hand of the photographer character in response to the input and sets at least one of a position and a shooting direction of the camera in response to the movement of the hand.

A specific example of an animation production system 300 according to an embodiment of the present invention will be described below with reference to the drawings. It should be noted that the present invention is not limited to these examples, and is intended to include all modifications within the meaning and scope of equivalence with the appended claims, as indicated by the appended claims. In the following description, the same elements are denoted by the same reference numerals in the description of the drawings and overlapping descriptions are omitted.

### <Overview>

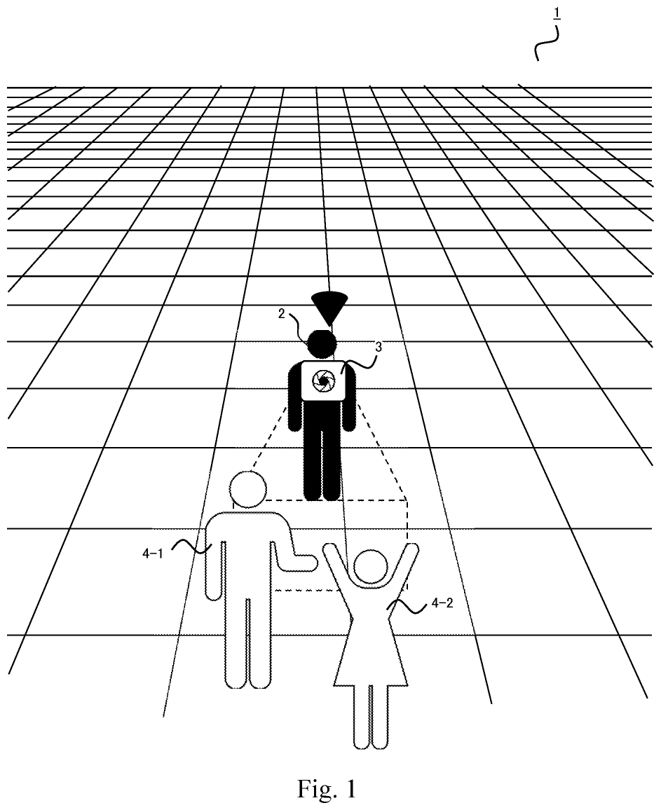

FIG. 1 is a diagram illustrating an example of a virtual space displayed on a head mount display (HMD) mounted by a user in an animation production system 300 according to the present embodiment. In the animation production system 300 of the present embodiment, a virtual character 4 and a virtual camera 3 are disposed in the virtual space 1, and a character 4 is shot using the camera 3. In the virtual space 1, a photographer 2 (a character of the photographer) is disposed, and the camera 3 is virtually operated by the photographer 2. In the animation production system 300 of this embodiment, as shown in FIG. 1, the user arranges the character 4 and the camera 3 while viewing the virtual space 1 in TPV (Third Person View) from the higher perspective, shoots the character 4 in the FPV (First Person View) as the photographer 2, and performs the performance of the character 4 in the FPV, while producing the animation. In the virtual space 1, a plurality of characters 4 (in the example of FIG. 1, characters 4-1 and 4-2) can be disposed, and the user can perform the performance while possessing a character 4. If more than one character 4 is disposed, the user may also switch the object possessed by each character 4 (e.g., characters 4-1 and 4-2). That is, in the animation production system 300 of the present embodiment, one can play a number of roles (roles). In addition, since the camera 2 can be virtually operated as the photographer 2, natural camera work can be realized and the representation of the movie to be shot can be enriched.

### <General Configuration>

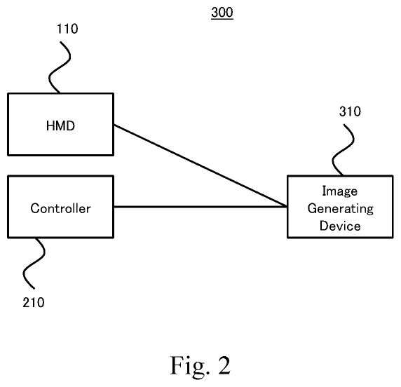

FIG. 2 is a diagram illustrating an example of the overall configuration of an animation production system 300 according to an embodiment of the present invention. The animation production system 300 may comprise, for example, an HMD 110, a controller 210, and an image generating device 310 that functions as a host computer. An infrared camera (not shown) or the like can also be added to the animation production system 300 for detecting the position, orientation and tilt of the HMD 110 or controller 210. These devices may be connected to each other by wired or wireless means. For example, each device may be equipped with a USB port to establish communication by cable connection, or communication may be established by wired or wireless, such as HDMI, wired LAN, infrared, Bluetooth™, WiFi™. The image generating device 310 may be a PC, a game machine, a portable communication terminal, or any other device having a calculation processing function.

### <HMD 110>

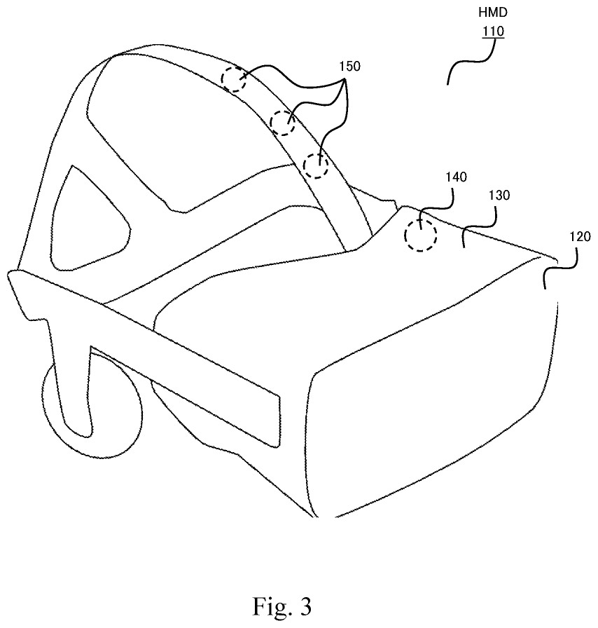

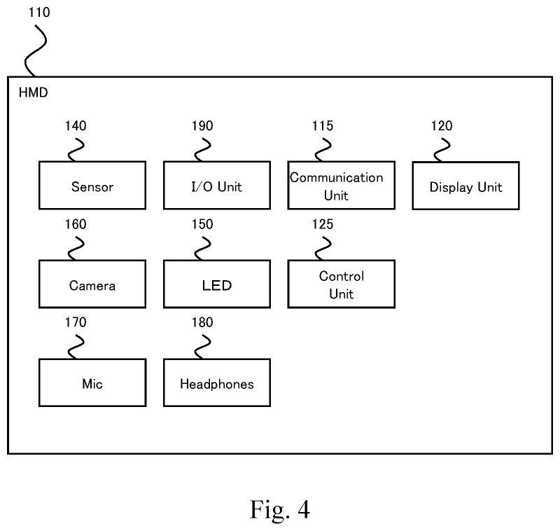

FIG. 3 is a diagram schematically illustrating the appearance of the HMD 110 according to the present embodiment. FIG. 4 is a diagram illustrating an example of a functional configuration of the HMD 110 according to the present embodiment.

The HMD 110 is mounted on the user's head and includes a display panel 120 for placement in front of the user's left and right eyes. Although the display panel 120 may be an optically transmissive or non-transmissive display, the present embodiment illustrates a non-transmissive display panel that can provide more immersion. The display panel 120 displays a left-eye image and a right-eye image, which can provide the user with a three-dimensional image by utilizing the parallax of both eyes. If left-eye and right-eye images can be displayed, a left-eye display and a right-eye display can be provided separately, and an integrated display for left-eye and right-eye can be provided.

The housing portion 130 of the HMD 110 includes a sensor 140. Sensor 140 may comprise, for example, a magnetic sensor, an acceleration sensor, or a gyro sensor, or a combination thereof, to detect movements such as the orientation or tilt of the user's head. When the vertical direction of the user's head is Y-axis, the axis corresponding to the user's anteroposterior direction is Z-axis, which connects the center of the display panel 120 with the user, and the axis corresponding to the user's left and right direction is X-axis, the sensor 140 can detect the rotation angle around the X-axis (so-called pitch angle), rotation angle around the Y-axis (so-called yaw angle), and rotation angle around the Z-axis (so-called roll angle).

In place of or in addition to the sensor 140, the housing portion 130 of the HMD 110 may also include a plurality of light sources 150 (e.g., infrared light LEDs, visible light LEDs). A camera (e.g., an infrared light camera, a visible light camera) installed outside the HMD 110 (e.g., indoor, etc.) can detect the position, orientation, and tilt of the HMD 110 in a particular space by detecting these light sources. Alternatively, for the same purpose, the HMD 110 may be provided with a camera for detecting a light source installed in the housing portion 130 of the HMD 110.

The housing portion 130 of the HMD 110 may also include an eye tracking sensor. The eye tracking sensor is used to detect the user's left and right eye gaze directions and gaze. There are various types of eye tracking sensors. For example, the position of reflected light on the cornea, which can be irradiated with infrared light that is weak in the left eye and right eye, is used as a reference point, the position of the pupil relative to the position of reflected light is used to detect the direction of the eye line, and the intersection point in the direction of the eye line in the left eye and right eye is used as a focus point.

### <Controller 210>

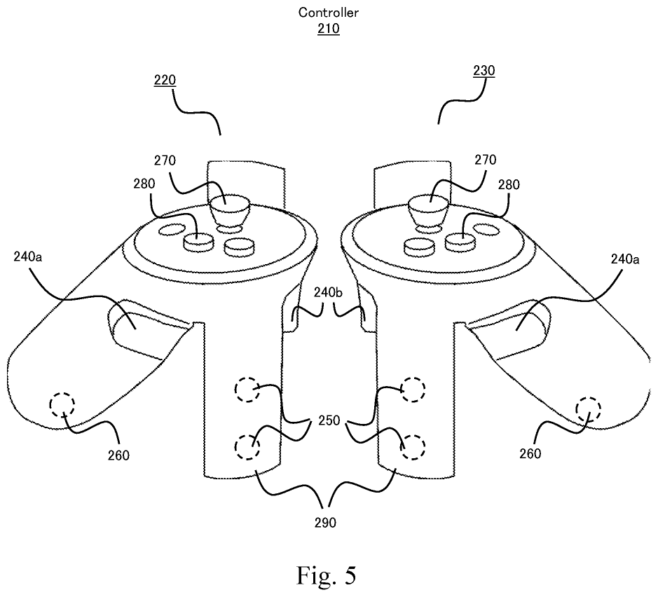

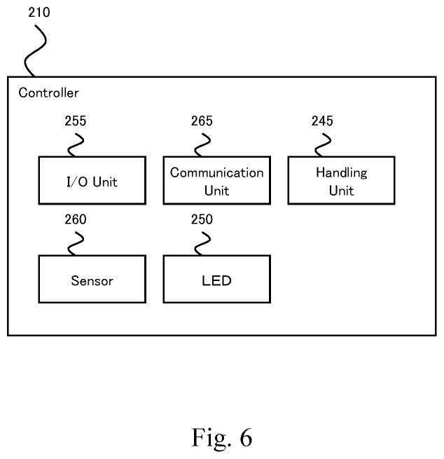

FIG. 5 is a diagram schematically illustrating the appearance of the controller 210 according to the present embodiment. FIG. 6 is a diagram illustrating an example of a functional configuration of a controller 210 according to this embodiment.

The controller 210 can support the user to make predetermined inputs in the virtual space. The controller 210 may be configured as a set of left-hand 220 and right-hand 230 controllers. The left hand controller 220 and the right hand controller 230 may each have an operational trigger button 240, an infrared LED 250, a sensor 260, a joystick 270, and a menu button 280.

The operation trigger button 240 is positioned as 240a, 240b in a position that is intended to perform an operation to pull the trigger with the middle finger and index finger when gripping the grip 235 of the controller 210. The frame 245 formed in a ring-like fashion downward from both sides of the controller 210 is provided with a plurality of infrared LEDs 250, and a camera (not shown) provided outside the controller can detect the position, orientation and slope of the controller 210 in a particular space by detecting the position of these infrared LEDs.

The controller 210 may also incorporate a sensor 260 to detect movements such as the orientation and tilt of the controller 210. As sensor 260, it may comprise, for example, a magnetic sensor, an acceleration sensor, or a gyro sensor, or a combination thereof. Additionally, the top surface of the controller 210 may include a joystick 270 and a menu button 280. It is envisioned that the joystick 270 may be moved in a 360 degree direction centered on the reference point and operated with a thumb when gripping the grip 235 of the controller 210. Menu buttons 280 are also assumed to be operated with the thumb. In addition, the controller 210 may include a vibrator (not shown) for providing vibration to the hand of the user operating the controller 210. The controller 210 includes an input/output unit and a communication unit for outputting information such as the position, orientation, and slope of the controller 210 via a button or a joystick, and for receiving information from the host computer.

With or without the user grasping the controller 210 and manipulating the various buttons and joysticks, and with information detected by the infrared LEDs and sensors, the system can determine the movement and attitude of the user's hand, pseudo-displaying and operating the user's hand in the virtual space.

### <Image Generator 310>

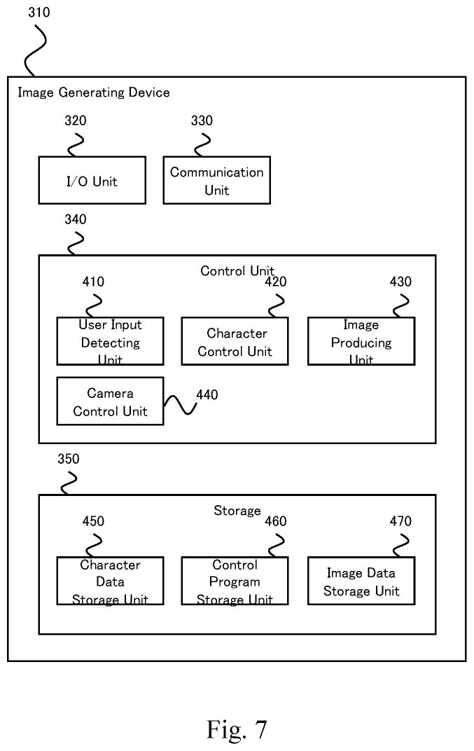

FIG. 7 is a diagram illustrating an example of a functional configuration of an image producing device 310 according to this embodiment. The image producing device 310 may use a device such as a PC, a game machine, a portable communication terminal, or the like, which has a function for storing information on the user's head movement or the movement or operation of the controller acquired by the user input information or the sensor, which is transmitted from the HMD 110 or the controller 210, performing a predetermined computational processing, and generating an image. The image producing device 310 may include an input/output unit 320 for establishing a wired connection with a peripheral device such as, for example, an HMD 110 or a controller 210, and a communication unit 330 for establishing a wireless connection such as infrared, Bluetooth, or WiFi (registered trademark). The information received from the HMD 110 and/or the controller 210 regarding the movement of the user's head or the movement or operation of the controller is detected in the control unit 340 as input content including the operation of the user's position, line of sight, attitude, speech, operation, etc. through the I/O unit 320 and/or the communication unit 330, and a control program stored in the storage unit 350 is executed in accordance with the user's input content to perform a process such as controlling the character 4 and generating an image. The control unit 340 may be composed of a CPU. However, by further providing a GPU specialized for image processing, information processing and image processing can be distributed and overall processing efficiency can be improved. The image generating device 310 may also communicate with other computing processing devices to allow other computing processing devices to share information processing and image processing.

The control unit 340 includes a user input detecting unit 410 that detects information received from the HMD 110 and/or the controller 210 regarding the movement of the user's head and the movement or operation of the controller, a character control unit 420 that executes a control program stored in the control program storage unit 460 for a character 4 stored in the character data storage unit 450 of the storage unit 350, a camera control unit 440 that controls the virtual camera 3 disposed in the virtual space 1 according to the character control, and an image producing unit 430 that generates an image in which the camera 3 captures the virtual space 1 based on the character control. Here, the movement of the character 4 is controlled by converting information such as the direction, inclination, and hand movement of the user head detected through the HMD 110 or the controller 210 into the movement of each part of the bone structure created in accordance with the movement or restriction of the joints of the human body, and applying the bone structure movement to the previously stored character data. The control of the camera 3 is performed, for example, by changing various settings (e.g., the position of the camera 3 within the virtual space 1, the shooting direction, the focus position, and the zoom of the camera 3) with respect to the camera 3 according to the movement of the hand of the character 4.

The storage unit 350 stores in the aforementioned character data storage unit 450 information related to the character 4, such as the attribute of the character 4, as well as the image data of the character 4. The control program storage unit 460 stores a program for controlling the operation and expression of the character 4 in the virtual space and controlling an object such as the camera 3. The image data storage unit 470 stores the image generated by the image producing unit 430.

### <Camera Operation>

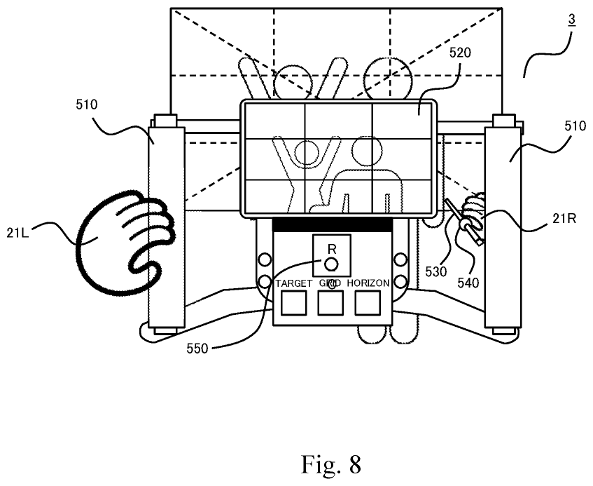

FIG. 8 is a diagram illustrating the operation of the camera 3 by the camera man 2 in the animation production system 300 according to the present embodiment. In FIG. 8, it is assumed that the user's possession target (to be operated) is set to the cameraman 2.

Each of the cameras 3 is provided with a handle 510 on both sides. The character control unit 420 (which may be the camera control unit 440; the same shall apply hereinafter) controls the movement of the hand 21 of the cameraman 2 in response to an input from the controller 210. For example, the position of the hand 21 is controlled in response to the position of the controller 210 and the grasping action of the hand 21 is controlled in response to the pushing of the trigger button 240. When the user's hand 21 grips the handle 510, the camera control unit 440 changes the position, posture (shooting direction), and focus position of the camera 3 according to the movement of the hand 21. The image displayed on the display unit 510 changes depending on the position, the posture, the focal position, and so forth of the camera 3. That is, in the virtual space 1, the user can implement the camera work of the camera 3 by operating the controller 210. Since the user can operate the camera 3 with both hands, it is possible to perform the same camera work operation as the actual professional camera. In addition, the camera control unit 440 can perform a so-called image stabilization process in order to suppress shaking associated with the operation of the virtual camera 3 by the cameraman 2 possessed by the user. For example, the camera control unit 440 can record an image that enters the image angle (captured area) of the camera 3 in a buffer, calculate the movement amount by comparing the image (entered in the image angle) taken at the time of recording with the image (entered in the image angle) taken at the time of recording, or can detect a change in the attitude (the photographing direction) of the camera 3 by operation, calculate the movement amount of the shooting area according to the change in the attitude, and perform image stabilization by shifting the image angle (the photographed area) according to the calculated movement amount.

A display unit 520 is provided in the camera 3. In the display unit 520, an image captured by the camera 3 in the virtual space 1 is displayed. The user can operate the camera 3 while checking the image displayed on the display unit 520. That is, the cameraman 2 can operate the camera 3 in the virtual space 1 with the actual camera work as it is. In the vicinity of the display unit 520, a recording button 550 is disposed. When a recording button 550 is pressed, the image producing unit 430 records the image taken by the camera 3 as a moving image in the image data storage unit 470. When the recording button 550 is pressed again, the recording by the image producing unit 430 ends.

A slider 540 is also disposed on the camera 3. The user may move the hand 21 to grasp the slider 540 and move the slider 540 along the rail 530. In this embodiment, the race 530 is provided between the camera 3 and the subject to be shot (e.g., the character 4) and extends parallel to the anteroposterior direction (a direction parallel to the shooting direction of the camera 3 in which the shooting direction of the camera 3 is forward). The camera control unit 440 may adjust the zoom of the camera 3 in response to movement of the slider 540. For example, when the camera control unit 440 is moved so that the slider 540 is closer to the shooting object (in the shooting direction of the camera 3), the magnification ratio of the zoom of the camera 3 can be increased, and when the slider 540 is moved so that the slider 540 is closer to the camera 3 (in the direction opposite to the shooting direction of the camera 3), the magnification ratio of the zoom of the camera 3 can be reduced. The direction in which the slider 540 moves (the longitudinal direction of the rail 530) may not be parallel to the photographing direction of the camera, for example, the vertical direction or the left-right direction. The slider 540 may also be a rotational or spiral action instead of a linear operation.

### <Operation>

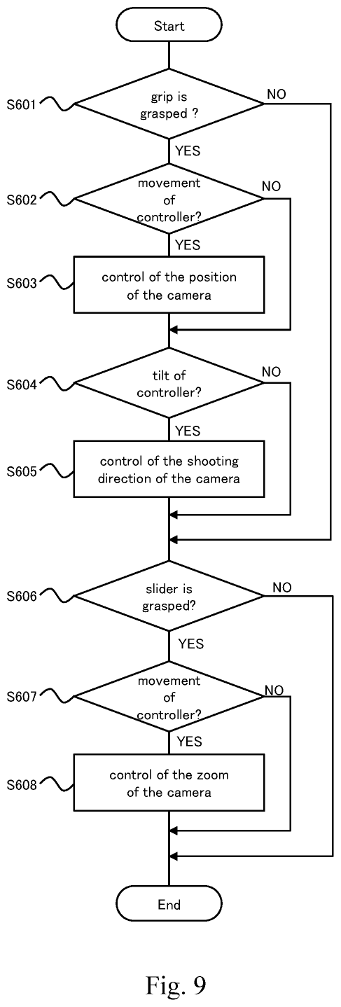

FIG. 9 is a diagram illustrating an operation of an animation production system 300 according to this embodiment. The operation shown in FIG. 9 can be executed whether or not recording is being performed.

When the grip 510 of the camera 3 is grasped by the user's hand 21 (S601:YES), if the movement of the controller 211 exists (S602:YES), the camera control unit 440 moves the position of the camera 3 according to the movement (S603), and if the pose of the controller 210 changes (S604:YES), the camera control unit 440 changes the shooting direction of the camera 3 according to the pose (S605).

When the slider 540 is grasped by the user's hand 21 (S606:YES), if the movement of the controller 211 exists (S607:YES), the camera control unit 440 adjusts the zoom of the camera 3 according to the movement (S608).

In this manner, the user may use the controller 210 to manipulate the camera 3 as well as the real world.

According to the animation production system 300 of the present embodiment, a user can operate the camera 3 as a camera man 2 in the virtual space 1 to take video images. Accordingly, since the camera 3 can be operated in the same way as in the real world to take photographs, it is possible to realize a natural camera work and to provide a richer representation of the animated video.

Although the present embodiment has been described above, the above-described embodiment is intended to facilitate the understanding of the present invention and is not intended to be a limiting interpretation of the present invention. The present invention may be modified and improved without departing from the spirit thereof, and the present invention also includes its equivalent.

For example, in the present embodiment, the image generating device 310 may be a single computer, but not limited to the HMD 110 or the controller 210 may be provided with all or some of the functions of the image generating device 310. It may also include a function of a portion of the image generating device 310 to other computers that are communicatively connected with the image generating device 310.

In the present exemplary embodiment, a virtual space based on the virtual reality (VR; Virtual Reality) was assumed. However, the animation production system 300 of the present exemplary embodiment is not limited to an extended reality (AR; Augmented Reality) space or a complex reality (MR; Mixed Reality) space, but the animation production system 300 of the present exemplary embodiment is still applicable.

### EXPLANATION OF SYMBOLS

1 virtual space
2 cameraman
3 cameras
4 characters
110 HMD
120 display panel
130 housing
140 sensor
150 light source
210 controller
220 left hand controller
230 right hand controller
235 grip
240 trigger button
250 Infrared LED
260 sensor
270 joystick
280 menu button
300 Animation Production System
310 Image Generator
320 I/O portion
330 communication unit
340 control unit
350 storage
410 User Input Detector
420 character control unit
430 Image Generator
440 Camera Control
450 character data storage unit
460 Program Storage
470 Image Data Storage
510 handle
520 display
530 rail
540 slider
550 recording button

1. An animation production system comprising:
a virtual camera that takes a picture of a character placed in a virtual space;
a user input detection unit that detects an input of a user from at least one of a head mounted display and a controller which the user mounts; and
a camera control unit that controls the camera in response to the input,

2. The animation production system according to claim 1, further comprising a slider parallel to a shooting direction of the camera,
wherein the camera control unit moves the slider in response to the input and determines the zoom of the camera according to the position of the slider.

3. The animation production system according to claim 1, wherein
the camera includes a virtual handle,
a photographer character who operates the camera is disposed in the virtual space, and
the camera control unit controls the movement of a hand of the photographer character in response to the input and sets at least one of a position and a shooting direction of the camera in response to the movement of the hand.
